(19) United States
(12) Patent Application Publication
(10) Pub. No.: US 2006/0281857 A1
(43) Pub. Date: Dec. 14, 2006

(54) Oligocarbonate-containing coating compositions for scratch-resistant topcoats

(75) Inventors: Steffen Hofacker, Odenthal (DE); Christian Wamprecht, Neuss (DE); Markus Mechtel, Bergisch Gladbach (DE); Nusret Yuva, Burscheid (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/448,231

(22) Filed: Jun. 7, 2006

(30) Foreign Application Priority Data
Jun. 10, 2005 (DE) 102005026863.3

(51) Int. Cl. C08G 18/08

(52) U.S. Cl. 524/589

(57) ABSTRACT

Coating compositions comprising polyisocyanates, aliphatic oligocarbonate polyols and polyacrylate polyols are provided. The compositions comprise A) a polyol component composed of a) 1% to 50% by weight of aliphatic oligocarbonate polyols having a number-average molecular weight Mₙ of 200 to 5000 g/mol and b) 50% to 99% by weight of hydroxy-functional polyacrylate polyols; and B) one or more OH-reactive (poly)isocyanate crosslinkers having an average NCO functionality of ≧2.0. A process for preparing the coatings are also provided.

### CROSS-REFERENCE TO RELATED APPLICATION

This application claims priority under 35 U.S.C. § 119 (a-e) to German application 10 2005 026863, filed Oct. 10, 2005.

### FIELD OF THE INVENTION

The present invention relates to new coating compositions comprising polyisocyanates, aliphatic oligocarbonate polyols and polyacrylate polyols, to a process for preparing them and to their use for producing coatings.

### BACKGROUND OF THE INVENTION

Scratch-resistant topcoat materials, particularly for the automotive topcoat sector and also for automotive refinishing, have been of great interest for many years already. In addition to the characteristic that such topcoat materials ought to exhibit low propensity to scratching in, for example, a carwash, further requirements are that these coating systems must also exhibit pronounced solvent resistance and acid resistance.

In recent years in particular, accordingly, 2-component polyurethane systems have become established on the market, these systems being distinguished in particular by good resistance properties with respect to solvents and chemicals, in conjunction with effective scratch resistance and excellent weathering resistance.

Polyacrylates, optionally in a blend with polyesters, are often used as polyol binders in such systems. Serving as crosslinkers are, primarily, aliphatic and/or cycloaliphatic polyisocyanates based on hexamethylene diisocyanate and isophorone diisocyanate.

These 2K [two-component] polyurethane coating compositions have achieved a very good level of properties overall, and yet, particularly in the case of dark shades, scratching to the clearcoat is frequently observed after frequent washes in a carwash. Depending on the elasticity of the paint film, the scratches heal over time, which is referred to as reflow. If, however, the elasticity of the clearcoat film is increased with the aim of improving reflow, the finish loses surface hardness and there is a deterioration in particular in the solvent and chemical resistance, especially the acid resistance [Carl Hanser Verlag, Munich, MO Metalloberfläche 54 (2000) 60-64]. Efforts have accordingly been made in the prior art to enhance the scratch resistance of 2K PU coating materials by raising the elasticity, principally through combinations of polyacrylates and relatively elastic polyesters.

DE-A 198 24 118 describes low-solvent binders based on polyester acrylate, which with di- and/or polyisocyanates can be cured to give quick-drying coatings with effective adhesion. Because of the high polyester fraction, however, the acid resistance of these coatings is inadequate and they are unsuitable for use in automotive topcoats.

WO 96/20968 describes a coating composition for cars and lorries that comprises a polyacrylate based on alkyl-substituted cycloaliphatic (meth)acrylate monomers or alkyl-substituted aromatic vinyl monomers, a polyhydroxy-functional oligoester and a polyisocyanate. However, since, owing to their preparation, the oligoesters contain not only primary but also a fairly large number of secondary hydroxyl groups, and since for low-viscosity coating compositions (<3000 mpa·s/23° C.) it is necessary to use very large amounts of these esters (>60% by weight based on the overall formulation), the coating compositions cure only very slowly and at relatively high temperatures, and so are unsuitable for temperature-sensitive substrates.

EP-A 0 896 991 describes coating compositions based on polyacrylate/polyester mixtures, having polyester fractions ≦10% by weight and hydroxyl numbers of 40 to 125 mg KOH/g. Owing to the resultant low crosslinking density, the PU coatings produced from them lack sufficient solvent and chemical. Furthermore, the viscosity, at 3000 to 5000 mPas/23° C. for a solids content of 70% by weight, is too high for the formulation of high-solids PU coating materials.

In the prior art, such as in EP 1 101 780 A, EP 819 710 A and EP 778 298 A, there is often a blanket reference to the use of mixtures of polyacrylates with other polyols, such as polyesters and/or polycarbonates, as polyol binders and reaction partners for polyisocyanate crosslinkers in 2K PU coating materials, but without any addressing of the specific advantages of these particular mixtures. Furthermore, no details are given of the quantitative composition, or of the molecular weight and OH functionality of the polycarbonate polyol, of such hybrid systems.

It was an object of the present invention, therefore, to provide new coating compositions which exhibit an improvement in scratch resistance without adverse effect on the acid resistance and solvent resistance of the topcoat systems.

### SUMMARY OF THE INVENTION

*It has been found that through the use of oligocarbonate polyols in defined combinations with polyacrylate polyols and polyisocyanates it is possible to prepare coating compositions which exhibit a significantly improved scratch resistance with an accompanying improvement in solvent resistance and acid resistance properties.

The invention accordingly provides coating compositions comprising
A) a polyol component composed of
   a) 1% to 50% by weight of aliphatic oligocarbonate polyols having a number-average molecular weight Mₙ of 200 to 5000 g/mol and
   b) 50% to 99% by weight of hydroxy-functional polyacrylate polyols and
B) one or more OH-reactive (poly)isocyanate crosslinkers having an average NCO functionality of ≧2.0.

The amount of a) and b) together adds up to 100% by weight.

### DETAILED DESCRIPTION OF PREFERRED EMBODIMENTS

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

In a) it is preferred to use aliphatic oligocarbonate polyols which have a number-average molecular weight of 200 to 2000 g/mol, more preferably 200 to 1000 g/mol.

In a), it is preferred to use aliphatic oligocarbonate polyols of the aforementioned kind which have an OH functionality of 1.5 to 5, more preferably 1.7 to 3, very preferably 1.9 to 2.5.

Preferably the amount of component a) is 1% to 20% by weight and that of component b) is 80% to 99% by weight, with particular preference a) is used in amounts of 1% to 10% by weight and b) in amounts of 90% to 99% by weight.

The aliphatic oligocarbonate polyols used in a) can be prepared by transesterifying monomeric dialkyl carbonates such as dimethyl carbonate, diethyl carbonate, etc., with polyols having an OH functionality ≧2.0 such as 1,4-butanediol, 1,3-butanediol, 1,5-pentanediol, 1,6-hexanediol, 3-methyl-1,5-pentanediol, 1,12-dodecanediol, cyclohexanedimethanol, trimethylolpropane, etc., and is described exemplarily in EP 1 404 740 B1 Ex. 1 to 5, EP 1 477 508 A1 Ex. 3.

For the coating compositions of the invention it is preferred to use aliphatic oligocarbonate diols and more preferably aliphatic oligocarbonate diols having a molecular weight of 200 to 2000 g/mol based on 1,4-butanediol, 1-6-hexanediol, 3-methyl-1,5-pentanediol, cyclohexanedimethanol or mixtures thereof.

The polyacrylate polyols b) employed are obtainable by using methods known to the skilled person to copolymerize
b1) 0 to 10% by weight of one or more, optionally functional, polybutadienes having a number-average molecular weight of 500 to 10 000 g/mol and having a 1,2-pendant vinylic double bond fraction of at least 10 mol %, based on all of the vinylic double bonds present in the polybutadiene,
b2) 1% to 30% by weight of one or more unsaturated, aromatic monomers selected from the styrene, a-methylstyrene and vinyltoluene group,
b3) 20% to 80% by weight of one or more hydroxyalkyl esters of acrylic or methacrylic acid having primary hydroxyl groups,
b4) 0 to 30% by weight of one or more cycloaliphatic esters of acrylic or methacrylic acid and C₃ to C₁₂ monoalcohols,
b5) 10% to 60% by weight of one or more aliphatic esters of acrylic or methacrylic acid and C₁ to C₈ monoalcohols,
b6) 0.1% to 5% by weight of one or more α,β-unsaturated C₃-C₇ monocarboxylic or dicarboxylic acids or of one or more monoesters of maleic or fumaric acid and C₁ to C₁₄ monoalcohols, and
b7) 0 to 30% by weight of further copolymerizable compounds other than the compounds of components b1) to b6)
   with one another, the sum of the weight percentages of components b1) to b7) being 100% by weight.

Preferably the copolymers of component b) are composed of
b1) 0.1% to 8% by weight of one or more, optionally functional, polybutadienes having a number-average molecular weight of 500 to 5000 g/mol and having a 1,2-pendant vinylic double bond fraction of at least 20 mol %, based on all of the vinylic double bonds present in the polybutadiene,
b2) 2% to 28% by weight of styrene,
b3) 25% to 70% by weight of one or more compounds from the group consisting of hydroxyethyl acrylate, hydroxyethyl methacrylate and butane-1,4-diol monoacrylate,
b4) 0 to 25% by weight of one or more cycloaliphatic esters of acrylic or methacrylic acid and C₃ to C₁₂ monoalcohols,
b5) 15% to 60% by weight of one of more esters of acrylic or methacrylic acid and aliphatic C₁ to C₈ monoalcohols,
b6) 0.3% to 4% by weight of one or more compounds from the group consisting of acrylic acid, methacrylic acid, maleic monoesters and fumaric monoesters formed from the corresponding acids and C₁ to C₈ monoalcohols, and
b7) 0-25% by weight of one or more compounds from the group consisting of acrylonitrile, methacrylonitrile, hydroxypropyl (meth)acrylate, vinyl esters of aliphatic, optionally branched C₁-C₁₀ monocarboxylic acids, dialkyl or dicycloalkyl esters of maleic or fumaric acid and C₃ to C₈ monoalcohols,
   the sum of the weight percentages of components b1) to b7) being 100% by weight.

With particular preference the copolymer of component b) is composed of
b1) 0.2% to 6.0% by weight of one or more, optionally functional, polybutadienes having a number-average molecular weight of 500 to 3000 g/mol and having a 1,2-pendant vinylic double bond fraction of at least 30 mol %, based on all of the vinylic double bonds present in the polybutadiene,
b2) 5% to 25% by weight of styrene,
b3) 30% to 65% by weight of hydroxyethyl acrylate, hydroxyethyl methacrylate or mixtures thereof,
b4) 0 to 20% by weight of one or more compounds from the group consisting of isobornyl acrylate, isobornyl methacrylate, cyclohexyl (meth)acrylate, 3,5,5-trimethylcyclohexyl (meth)acrylate and 4-tert-butylcyclohexyl (meth)acrylate,
b5) 20% to 50% by weight of one or more esters of acrylic or methacrylic acid and aliphatic C₁ to C₈ monoalcohols,
b6) 0.5% to 3% by weight of acrylic acid, methacrylic acid or mixtures thereof,
b7) 0 to 20% by weight of one or more compounds from the group consisting of acrylonitrile, methacrylonitrile, hydroxypropyl (meth)acrylate, vinyl esters of aliphatic, optionally branched C₁-C₁₀ monocarboxylic acids and dialkyl or dicycloalkyl esters of maleic or fumaric acid and C₃ to C₈ monoalcohols,
   the sum of the weight percentages of components b1) to b7) being 100% by weight.

With very particular preference the copolymer of component b) is composed of
b1) 0.4% to 5% by weight of one or more, optionally functional, polybutadienes having a number-average molecular weight of 500 to 2000 g/mol and having a 1,2-pendant vinylic double bond fraction of at least 40 mol %, based on all of the vinylic double bonds present in the polybutadiene,
b2) 5% to 20% by weight of styrene,
b3) 30% to 60% by weight of hydroxyethyl acrylate, hydroxyethyl methacrylate or mixtures thereof,
b4) 0 to 15% by weight of one or more compounds from the group consisting of isobornyl acrylate, isobornyl methacrylate, cyclohexyl (meth)acrylate, 3,5,5-trimethylcyclohexyl (meth)acrylate and 4-tert-butylcyclohexyl (meth)acrylate,
b5) 25% to 45% by weight of one or more esters of acrylic or methacrylic acid and aliphatic C₁ to C₈ monoalcohols,
b6) 0.5% to 2% by weight of acrylic acid, methacrylic acid or mixtures thereof and
b7) 0 to 15% by weight of one or more compounds from the group consisting of hydroxypropyl (meth)acrylate, vinyl esters of aliphatic, optionally branched C₁ to C₉ monocarboxylic acids, dialkyl or dicycloalkyl esters of maleic or fumaric acid and C₃ to C₆ monoalcohols,
   the sum of the weight percentages of components b1) to b7) being 100% by weight.

The preparation of the resins of component b) is carried out by copolymerizing constituents b1) to b7) by customary methods familiar to the skilled person [Houben-Weyl (eds.): Methods of Organic Chemistry, 4th ed., E 20/2. Thieme, Stuttgart 1987, p. 1156], preference being given to free-radical solution polymerization of components a1) to b7) at temperatures from 140 to 240° C. in the presence of free-radical initiators.

The monomers and/or oligomers b1) to b7) are generally incorporated into the copolymer in the same proportions in which they are used for the polymerization. The distribution of the incorporated units is substantially random.

Suitable starting polymers b1) for the copolymers b) essential to the invention include in principle all polybutadienes having a number-average molecular weight of 500-10 000 g/mol which possess a fraction of vinylic double bonds in pendant 1,2-position of at least 10 mol %, preferably at least 20 mol %, more preferably at least 40 mol %, based on all of the vinyl double bonds present in the polybutadiene.

As compounds of component b1) it is typical to use polybutadiene isomer mixtures of whose vinylic double bonds 10 to 90 mol % are in 1,2-position, 10 to 70 mol % are in 1,4-cis and/or 1,4-trans position and 0 to 30 mol % are present in cyclic structures.

The polybutadienes employed may optionally also carry functional groups, such as hydroxyl groups or carboxyl groups, for example.

An overview of suitable polybutadienes of the abovementioned kind is given in “Makromoleküle” by H. G. Elias, 4th Edition, Hüthig and Wepf-Verlag, Basle, Heidelberg, New York, pages 676 and 744 to 746 and 1012 ff.

The copolymers b) can be prepared in the presence of a solvent. Examples of those suitable for this purpose include aliphatic, cycloaliphatic and/or aromatic hydrocarbons, such as alkylbenzenes, e.g. toluene, xylene; esters, such as ethyl acetate, n-propyl acetate, isopropyl acetate, n-butyl acetate, n-hexyl acetate, 2-ethylhexyl acetate, ethyl propionate, butyl propionate, pentyl propionate, ethylene glycol monoethyl ether acetate, the corresponding methyl ether acetate; ethers such as ethylene glycol acetate monomethyl, monoethyl or monobutyl ether; ketones such as acetone, methyl ethyl ketone, methyl isobutyl ketone, methyl n-amyl ketone or mixtures of such solvents.

The copolymers b) may be prepared continuously or batchwise.

In the case of continuous preparation the monomer mixture and the initiator are metered uniformly and continuously into a polymerization reactor and at the same time the corresponding amount of polymer is taken off continuously, so that very uniform copolymers are obtained.

In the case of a batchwise preparation, monomer mixture and initiator are metered into the polymerization reactor, the polymer remaining in the reactor. In order to obtain copolymers with as uniform a construction as possible, monomer mixture and initiator are metered into the reactor at a constant rate.

By uniform copolymers in the sense of the invention are meant copolymers having a narrow molecular weight distribution and a low polydispersity (M_{w}/Mₙ) of preferably ≦2.5 and also virtually identical monomer composition of the molecule chains.

Generally the copolymerization takes place in the temperature range from 140 to 240° C., preferably 145 to 220° C. and more preferably 150 to 200° C.

The copolymerization can be carried out under a pressure of up to 15 bar.

The initiators are used in amounts of 0.05% to 15%, preferably 1 to 10%, in particular 2 to 8%, by weight based on the total amount of components b1) to b7).

Suitable initiators for preparing the copolymers b) are customary free-radical initiators based on azo or peroxide compounds, but only those possessing a sufficiently long half-life for the polymerization in the abovementioned temperature range, viz a half-life of around 5 seconds to around 30 minutes. Suitable examples include 2,2′-azobis(2-methylpropanenitrile), 2,2′-azobis-(2-methylbutanenitrile), 1,1′-azobis(cyclohexanecarbonitrile), tert-butylperoxy-2-ethylhexanoate, tert-butyl peroxydiethylacetate, tert-butyl peroxyisobutyrate, 1,1-di-tert-butylperoxy-3,3,5-trimethylcyclohexane, 1,1-di-tert-butylperoxycyclohexane, tert-butyl peroxy-3,5,5-trimethylhexanoate, tert-butyl peroxyisopropylcarbonate, tert-butyl peroxyacetate, tert-butyl peroxybenzoate, dicumyl peroxide, tert-butyl cumyl peroxide, di-tert-butyl peroxide and di-tert-amyl peroxide.

In one particular embodiment the polyacrylate polyols are prepared in the presence of at least one of the oligocarbonate polyols a) in accordance with the processes described above. The polymerization may take place either in the absence of organic solvent, in which the oligocarbonate polyol constituents the reaction medium for the free-radical polymerization, or in mixtures of organic solvents and oligocarbonate polyols a).

The OH-reactive (poly)isocyanate crosslinkers B) are any desired polyisocyanates prepared by modifying simple aliphatic, cycloaliphatic, araliphatic and/or aromatic diisocyanates, being constructed from at least two diisocyanates, and having a uretdione, isocyanurate, allophanate, biuret, iminooxadiazinedione and/or oxadiazinetrione structure, as described exemplarily in, for example, J. Prakt. Chem. 336 (1994) 185-200, in texts DE-A 16 70 666, 19 54 093, 24 14 413, 24 52 532, 26 41 380, 37 00 209, 39 00 053 and 39 28 503 or in EP-A 336 205, 339 396 and 798 299.

Suitable diisocyanates for preparing such polyisocyanates are any desired diisocyanates of the molecular weight range 140 to 400 g/mol that are obtainable by phosgenation or by phosgene-free processes, as for example by thermal urethane cleavage, and have aliphatically, cycloaliphatically, araliphatically and/or aromatically attached isocyanate groups, such as 1,4-diisocyanatobutane, 1,6-diisocyanatohexane (HDI), 2-methyl-1,5-diisocyanatopentane, 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanato-methylcyclohexane (isophorone diisocyanate, IPDI), 4,4′-diisocyanatodicyclohexylmethane, 1-isocyanato-1-methyl-4(3)-isocyanatomethylcyclohexane, bis(isocyanatomethyl)norbornane, 1,3- and 1,4-bis(2-isocyanatoprop-2-yl)benzene (TMXDI), 2,4- and 2,6-diisocyanatotoluene (TDI), 2,4′- and 4,4′-diisocyanatodiphenylmethane (MDI), 1,5-diisocyanatonaphthalene or any desired mixtures of such diisocyanates.

The polyisocyanates or polyisocyanate mixtures in question are preferably those of the stated kind containing exclusively aliphatically and/or cycloaliphatically attached isocyanate groups.

Very particular preference is given to polyisocyanates or polyisocyanate mixtures with an isocyanurate structure, based on HDI, IPDI and/or 4,4′-diisocyanato-dicyclohexylmethane.

Additionally it is also possible to use what are called blocked polyisocyanates and/or isocyanates, preferably blocked polyisocyanates or polyisocyanate mixtures, very preferably blocked polyisocyanates or polyisocyanate mixtures with an isocyanurate structure and based on HDI, IPDI and/or 4,4′-diisocyanato-dicyclohexylmethane.

The blocking of (poly)isocyanates for temporary protection of the isocyanate groups is a well-established working method and is described for example in Houben Weyl, Methoden der organischen Chemie XIV/2, pp. 61-70.

Suitable blocking agents include all compounds which can be eliminated when the blocked (poly)isocyanate is heated, optionally in the presence of a catalyst. Examples of suitable blocking agents include sterically bulky amines such as dicyclohexylamine, diisopropylamine, N-tert-butyl-N-benzylamine, caprolactam, butanone oxime, imidazoles with the various possible substitution patterns, pyrazoles such as 3,5-dimethylpyrazole, triazoles and tetrazoles, and alcohols such as isopropanol and ethanol. An additional possibility is to block the isocyanate group in such a way that, in a continuing reaction, instead of the blocking agent being eliminated, the intermediate formed is consumed by reaction. This is the case in particular for cyclopentanone 2-carboxyethyl ester, which in the thermal crosslinking reaction is incorporated fully by reaction into the polymeric network and is not eliminated again.

Particularly with the use of blocked polyisocyanates it is possible likewise to use further, reactive compounds, having groups which are reactive towards OH or NH groups, as additional crosslinker components alongside component B). Examples of these are amino resins.

Resins regarded as amino resins are the condensation products, familiar to paint technology, of melamine and formaldehyde, or of urea and formaldehyde. Suitability is possessed by all conventional melamine-formaldehyde condensates which are unetherified or are etherified with saturated monoalcohols having 1 to 4 carbon atoms. Where other crosslinker components are used it is necessary to adjust the amount of binder containing NCO-reactive hydroxyl groups accordingly.

Catalysts which can be used for the reaction of components A) with component B) for preparing the coating compositions of the invention are catalysts such as commercially customary organometallic compounds of the elements aluminium, tin, zinc, titanium, manganese, iron, bismuth or else zirconium, such as dibutyltin laurate, zinc octoate and titanium tetraisopropoxide. Also suitable in addition, however, are tertiary amines such as 1,4-diazabicyclo[2.2.2]octane, for example.

A further possibility is to accelerate the reaction of component B) with component A) by carrying out curing at temperatures between 20 and 200° C., preferably between 60 and 180° C., more preferably between 70 and 150° C.

Besides the polyol mixture A) essential to the invention it is also possible to use further organic polyhydroxyl compounds or aminic reactive diluents that are known to the skilled person from polyurethane coating technology.

These other polyhydroxyl compounds may be the customary polyester polyols, polyether polyols, polyurethane polyols or further, hitherto undescribed, polycarbonate polyols and polyacrylate polyols. As further organic polyhydroxyl compounds, if such compounds are employed at all alongside the polyol component A) essential to the invention, it is preferred to use the conventional, prior art polyacrylate polyols and/or polyester polyols. The aminic reactive diluents may be products containing blocked amino groups, such as aldimines or ketimines, or products containing amino groups which are still free but are attenuated in their reactivity, such as aspartic esters. As a general rule the aminic reactive diluents have more than one (blocked) amino group, and so contribute to the structure of the polymeric paint film network in the course of the crosslinking reaction.

If alongside the polyol component A) of the invention use is made of further polyhydroxyl compounds or aminic reactive diluents of the aforementioned kind, the fraction of these additional, isocyanate-reactive compounds is not more than 50% by weight, preferably not more than 30% by weight, based on the amount of component A) essential to the invention. With particular preference, however, the inventively essential polyol component A) is used as the sole polyol in the coating compositions of the invention.

The ratio of component B) to component A) and, optionally, further crosslinkers and curing agents is made such as to result in an NCO/OH ratio of the free and optionally blocked NCO groups to the isocyanate-reactive groups of 0.3 to 2, preferably 0.4 to 1.5, more preferably 0.5 to 1.2.

In the inventively essential coating compositions it is possible in addition to the components A) and B) essential to the invention to use auxiliaries which are customary in coating technology, such as organic or inorganic pigments, further organic light stabilizers, free-radical scavengers, coatings additives, such as dispersants, flow control agents, thickeners, defoamers and other auxiliaries, adhesion agents, fungicides, bactericides, stabilizers or inhibitors and further catalysts.

The coating compositions of the invention are employed preferably in the sectors of plastics coating, general industrial coating, large-vehicle coating, automotive refinish, original automotive coating, floor coating and/or wood/furniture coating. Also provided, therefore, are coatings and coated substrates obtainable using the coating compositions of the invention.

### EXAMPLES

Desmophen® A 870: hydroxyl-containing polyacrylate from Bayer MaterialScience A G, Leverkusen, D E; about 70% strength in butyl acetate, hydroxyl content to DIN 53 240/2: around 2.95%.

Desmophen® VP LS 2971: elasticizing, hydroxyl-containing polyester Desmophen from Bayer MaterialScience A G, Leverkusen, D E; about 80% strength in butyl acetate, hydroxyl content to DIN 53 240/2: around 3.8%.

Desmodur® N 3600: aliphatic polyisocyanurate from Bayer MaterialScience A G, Leverkusen, D E; 100% by weight, with an NCO content to DIN EN ISO 11909 of 23% by weight

Desmodur® N 3390 BA: aliphatic polyisocyanurate from Bayer MaterialScience A G, Leverkusen, D E; 90% by weight in n-butyl acetate, with an NCO content to DIN EN ISO 11909 of 19.6% by weight

The hydroxyl number (OH number) was determined in accordance with DIN 53240-2.

The viscosity was determined using a “RotoVisco1” rotational viscometer from Haake, Germany in accordance with DIN EN ISO 3219.

The acid number was determined in accordance with DIN EN ISO 2114.

The colour number (APHA) was determined in accordance with DIN EN 1557.

### Example 1

### Preparation of an Aliphatic Oligocarbonate Diol Based on 1,6-hexanediol and Having a Number-average Molecular Weight of 1000 g/mol

A 5 1 pressure reactor with top-mounted distillation unit, stirrer and receiver was charged with 2943 g of 1,6-hexanediol, containing 0.7 g of ytterbium(III) acetylacetonate, and with 1051 g of dimethyl carbonate at 80° C. The reaction mixture was subsequently heated to 150° C. over 2 h under a nitrogen atmosphere, and was held at that temperature under reflux and with stirring for 2 h, the pressure rising to 3.9 bar (absolute). The elimination product, methanol, was subsequently removed by distillation as a mixture with dimethyl carbonate, the pressure being lowered continuously over the course of 4 h by a total of 2.2 bar. Subsequently the distillation procedure was ended and a further 1051 g of dimethyl carbonate were pumped into the reaction mixture at 150° C., the reaction mixture being maintained at that temperature under reflux for 2 h with stirring, the pressure rising to 3.9 bar (absolute). Thereafter the methanol elimination product was again removed by distillation as a mixture with dimethyl carbonate, the pressure being lowered continuously over the course of 4 h by a total of 2.2 bar. The distillation procedure was then ended and a further 841 g of dimethyl carbonate were pumped into the reaction mixture at 150° C., the mixture being held at that temperature under reflux for 2 h with stirring, the pressure rising to 3.5 bar (absolute). Thereafter the methanol elimination product was again removed by distillation as a mixture with dimethyl carbonate, the pressure being lowered to atmospheric pressure over the course of 4 h. Subsequently the reaction mixture was heated to 180° C. over the course of 2 h and held at that temperature for 2 h with stirring. After that the temperature was reduced to 130° C. and a stream of nitrogen (5 1/h) was passed through the reaction mixture, during which the pressure was lowered to 20 mbar. Thereafter the temperature was raised to 180° C. over 4 h, and held there for 6 h. This was followed by the further removal of methanol, as a mixture with dimethyl carbonate, from the reaction mixture. After introduction of air and cooling of the reaction batch to room temperature, a colourless, waxlike oligocarbonate diol was obtained which had the following characteristics:

Mₙ=1035 g/mol; OH number=108.2 mg KOH/g; viscosity: 510 mPas at 75° C.

### Example 2

### Preparation of an Aliphatic Oligocarbonate Diol Based on 3-methyl-1,5-pentanediol and Having a Number-average Molecular Weight of 650 g/mol

Procedure as in Example 1, initially introducing, instead of 1,6-hexanediol, 34 092 g of 3-methyl-1,5-pentanediol and 8.0 g of ytterbium(III) acetylacetonate into a 60 1 pressure vessel and adding dimethyl carbonate in three steps, 10 223 g twice and 7147 g once.

This gave a colourless, liquid oligocarbonate diol having the following characteristics: Mₙ=675 g/mol; OH number=166.0 mg KOH/g; viscosity: 4146 mPas at 23° C.

### Example 3

### Preparation of an Aliphatic Oligocarbonate Diol Based on Cyclohexanedimethanol and Having a Number-average Molecular Weight of 500 g/mol

Procedure as in Example 1, adding, instead of 1,6-hexanediol, 3119 g of cyclohexanedimethanol and dimethyl carbonate in three steps, 659 g twice and 527 g once.

This gave a colourless, liquid oligocarbonate diol having the following characteristics: Mₙ=518 g/mol; OH number=216.4 mg KOH/g; viscosity: 5700 mPas at 75° C.

### Example 4

### Preparation of an Aliphatic Oligocarbonate Diol Based on Cyclohexanedimethanol and Having a Number-average Molecular Weight of 650 g/mol

Procedure as in Example 1, adding, instead of 1,6-hexanediol, 2018 g of cyclohexanedimethanol and dimethyl carbonate in three steps, 1101 g twice and 881 g once.

This gave a colourless, liquid oligocarbonate diol having the following characteristics: Mₙ=625 g/mol; OH number=179.3 mg KOH/g; viscosity: 14 000 mPas at 75° C.

### Example 5

### Preparation of an Aliphatic Oligocarbonate Diol Based on 3-methyl-1,5-pentanediol and Having a Number-average Molecular Weight of 500 g/mol

Procedure as in Example 1, initially adding, instead of 1,6-hexanediol, 3018 g of 3-methyl-1,5-pentanediol and adding dimethyl carbonate in three steps, 835 g twice and 668 g once.

This gave a colourless, liquid oligocarbonate diol having the following characteristics: Mₙ=539 g/mol; OH number=207.7 mg KOH/g; viscosity: 2500 mPas at 23° C.

### Example 6

### Preparation of an Aliphatic Oligoester Based on Trimethylolpropane

A reactor according to Example 7 was charged with 3155 g of trimethylolpropane, 1345 g of ε-caprolactone and 2.2 g of dibutyltin dilaurate (DBTL). The contents of the vessel were heated to 160° C., stirred at 160° C. for 6 hours and then cooled to 20° C., giving a clear resin having the following characteristics: solids content: 99.5% by weight, viscosity at 23° C.: 4100 mPa·s, acid number: 0.5 mg KOH/g, hydroxyl number: 881 mg KOH/g, hydroxyl content: 26.7% by weight, Hazen colour number: 44 APHA.

### Example 7

### Preparation Instructions for the Inventively Essential Copolymers A1 to A7

A 5-1 stainless steel pressure reactor with stirrer, distillation equipment, reservoir vessel for monomer mixture and initiator, including metering pumps and automatic temperature regulation, was charged with Part 1, which was then heated to the desired polymerization temperature. Then, beginning together and through separate feeds, Part 2 (monomer mixture) was metered in over 3 hours and Part 3 (initiator solution) over 3.5 hours, the polymerization temperature being kept constant (±2° C.). This was followed by stirring at the polymerization temperature for 60 minutes. After that, if a further Part 4 was employed, the batch was cooled to 80° C., the said Part 4 was metered in, and the mixture was stirred at 80° C. for 30 minutes. The batch was then cooled to room temperature and its solids content was measured. The copolymers ought to have a solids content of 70±1%. In the case of a solids content ≦68%, reactivation took place with 5% of the original amount of initiator, at 150° C. for 30 minutes. In the case of a solids content between 68% and 69%, distillation took place to 70±1%. Thereafter the copolymer was filtered through a filter (Supra T5500, pore size 25-72 μm, Seitz-Filter-Werke GmbH, Bad Kreuznach, DE). The compositions of Parts 1 to 4 and the characteristics of the products obtained are listed in Table 1.

TABLE 1

| Copolymer | A1 | A2 | A3 | A4 | A5 | A6 | A7 |
|---|---|---|---|---|---|---|---|
| Part 1 | | | | | | | |
| Butyl acetate | 23.18 | 23.18 | 23.18 | 23.18 | — | — | — |
| Solvent naphtha 100¹⁾ | — | — | — | — | 22.49 | 22.49 | 24.28 |
| Oligocarbonate diol from | 7.32 | 7.32 | 7.32 | 7.32 | — | — | — |
| Example No.: | (3) | (4) | (5) | (2) | | | |
| Part 2 | | | | | | | |
| Styrene | 16.45 | 16.45 | 16.45 | 16.45 | 9.72 | 9.72 | 10.49 |
| Hydroxyethyl ethacrylate | 30.13 | 30.13 | 30.13 | 30.13 | 19.64 | 19.64 | 21.19 |
| Butyl acrylate | 15.26 | 15.26 | 15.26 | 15.26 | 30.15 | 30.15 | 32.55 |
| Polybutadiene Nisso ® B | 0.66 | 0.66 | 0.66 | 0.66 | 0.86 | 0.86 | 0.93 |
| 1000²⁾ | | | | | | | |
| Acrylic acid | 0.66 | 0.66 | 0.66 | 0.66 | 0.98 | 0.98 | 1.05 |
| Part 3 | | | | | | | |
| Di-tert-butyl peroxide | 2.64 | 2.64 | 2.64 | 2.64 | 2.56 | 2.56 | 2.76 |
| Butyl acetate | 3.70 | 3.70 | 3.70 | 3.70 | 3.60 | 3.60 | 3.88 |
| Part 4 | | | | | | | |
| Oligoester Example No. 6 | — | — | — | — | 6.40 | 5.70 | 2.87 |
| Oligocarbonate Example | — | — | — | — | 0.70 | 1.40 | — |
| No. 2 | | | | | | | |
| Solvent naphtha 100¹⁾ | — | — | — | — | 2.90 | 2.90 | — |
| Polymerization | 170 | 170 | 170 | 170 | 160 | 160 | 165 |
| temperature ° C. | | | | | | | |
| Characteristics | 70.3 | 69.9 | 70.0 | 70.0 | 69.6 | 69.9 | 70.0 |
| Solids content, % by | | | | | | | |
| weight | | | | | | | |
| Viscosity at 23° C., mPa · s | 3313 | 3503 | 2221 | 2642 | 3753 | 4754 | 4204 |
| Acid number, as-supplied | 8.2 | 7.8 | 8.3 | 7.7 | 8.9 | 8.8 | 9.5 |
| form, mg KOH/g | | | | | | | |
| OH number, as-supplied | 143 | 144 | 149 | 132 | 132 | 134 | 113 |
| form, mg KOH/g | | | | | | | |
| OH content, solids, % by | 6.16 | 6.30 | 6.50 | 5.71 | 5.75 | 5.81 | 4.89 |
| weight | | | | | | | |
| Hazen colour number, | 56 | 29 | 38 | 49 | 39 | 34 | 37 |
| APHA | | | | | | | |

All amounts are to be understood as being percentages by weight.
¹⁾Commercial product from DHC Solvent Chemie GmbH, D-45478 Mülheim an der Ruhr
²⁾Commercial product from Nippon Soda, Japan

### Performance Examples

### Example 8

### Preparation of the Millbase (Component 8A)

112.2 g of polyol A7 were admixed with 8.7 g of the aliphatic oligocarbonate diol from Example 2, 1.34 g of Baysilone® OL 17 (10% strength solution in MPA; Borchers GmbH, Langenfeld), 2.69 g of Tinuvin® 292 (50% strength solution in MPA, Ciba Spezialitätenchemie Lampertheim GmbH, Lampertheim), 4.03 g of Tinuvin® 382/4 (50% strength solution in MPA, Ciba Spezialitätenchemie Lampertheim GmbH, Lampertheim), 1.34 g of Modaflow® (1% strength solution in MPA; Brenntag A G, Müilheim/R), 26.21 g of a 1:1 mixture of 1-methoxyprop-2-yl acetate and solvent naphtha 100, and the components were stirred together intimately.

### Preparation of the Curing Agent Solution (Component 8B)

47.2 g of Desmodur® N 3600 were admixed with 26.21 g of a 1:1 mixture of 1-methoxyprop-2-yl acetate and solvent naphtha 100 and the components were stirred together intimately.

### Examples 9-13

Procedure the same as in Example 8A or 8B, but using the raw materials listed in Table 2.

TABLE 2

| Millbase | 9 A | 10 A | 11 A | 12 A | 13 A |
|---|---|---|---|---|---|
| Polyol | A1 | A2 | A3 | A4 | A5 |
| Initial mass [g] | 95.9 | 95.5 | 94.6 | 98.8 | 118.4 |
| Baysilone ® OL 17 (10% MPA) | 1.07 | 1.07 | 1.07 | 1.07 | 1.34 |
| [g] | | | | | |
| Tinuvin ® 292 (50% MPA) [g] | 2.14 | 2.14 | 2.14 | 2.14 | 2.69 |
| Tinuvin ® 382/4 (50% MPA) [g] | 3.22 | 3.22 | 3.22 | 3.22 | 4.03 |
| Modaflow ® (1% MPA) [g] | 1.07 | 1.07 | 1.07 | 1.07 | 1.34 |
| 1-Methoxyprop-2-yl acetate/ | 26.2 | 26.0 | 26.2 | 25.7 | 25.3 |
| solvent naphtha 100 (1:1) [g] | | | | | |
| Curing agent | 9 B | 10 B | 11 B | 12 B | 13 B |
| Desmodur ® N 3600 [g] | | | | | 51.36 |
| Desmodur ® N 3390 BA [g] | 44.14 | 44.9 | 45.53 | 42.27 | |
| 1-Methoxyprop-2-yl acetate/ | 26.2 | 26.0 | 26.2 | 25.7 | 25.3 |
| solvent naphtha 100 (1:1) [g] | | | | | |

| | Comparative | | |
|---|---|---|---|
| | Example | | |
| | 1 | 2 | 3 |
| Millbase | | | |
| Polyol A7 from Table 1 [g] | — | — | 16.2 |
| Oligocarbonate diol from Example 2 [g] | — | — | 26.5 |
| Desmophen ® A 870 [g] | 64.6 | 86.9 | — |
| Desmophen ® VP LS 2971 [g] | 18.9 | — | — |
| Baysilone ® OL 17 (10% xylene) [g] | 0.9 | 0.9 | — |
| Baysilone ® OL 17 (10% MPA) [g] | — | — | 0.6 |
| Tinuvin ® 292 (10% xylene) [g] | 9.1 | 9.1 | — |
| Tinuvin ® 292 (50% MPA) [g] | — | — | 1.2 |
| Tinuvin ® 1130 (10% xylene) [g] | 18.1 | 18.1 | — |
| Tinuvin ® 382/4 (50% MPA) [g] | — | — | 1.8 |
| Modaflow ® (1% xylene) [g] | 0.9 | 0.9 | — |
| Modaflow ® (1% MPA) [g] | — | — | 0.6 |
| 1-Methoxyprop-2-yl acetate/solvent naphtha 100 | 11.9 | 8.7 | — |
| (1:1) [g] | | | |
| Butyl glycol acetate [g] | — | 3.6 | — |
| Curing agents | | | |
| Desmodur ® N 3390 BA [g] | 33.8 | 33.1 | 20.6 |
| 1-Methoxyprop-2-yl acetate/solvent naphtha 100 | 11.9 | 8.6 | 32.6 |
| (1:1) [g] | | | |

Mixing of the millbase with the curing agent, and application:

The components A (millbase) and B (curing agent) listed above were each mixed together and stirred intimately together. Thereafter the mixtures were each applied to metal coil coat panels, which had been prepainted with a black basecoat, using an airgun, and the applied mixtures were flashed off at room temperature for 10 minutes and then baked in a forced-air oven at 140° C. for 30 minutes. This gave bright, high-gloss coatings having a dry film thickness of approximately 40 μm.

An overview of the technical paint properties found for the coatings is depicted in Table 3.

TABLE 3
Technical properties of coatings

| | Example | | | | | | | | |
|---|---|---|---|---|---|---|---|---|---|
| | 8 | 9 | 10 | 11 | 12 | 13 | Comparative 1 | Comparative 2 | Comparative 3 |
| Pendulum hardness (s) on | 143 | 196 | 199 | 189 | 187 | 171 | 182 | 197 | 25 |
| glass | | | | | | | | | |
| FAM/XYLENE 10 min | 2/2 | 2/2 | 2/2 | 2/2 | 2/2 | 2/2 | 2/2 | 2/2 | 2/2 |
| Haze | 9 | 9 | 9 | 9 | 9 | 8 | 11 | 10 | 13 |
| Scratch resistance | | | | | | | | | |
| Gloss before (20°) | 86 | 89 | 89 | 89 | 89 | 87 | 91 | 92 | 79 |
| Gloss after 10 cycles | 76 | 62 | 61 | 64 | 63 | 68 | 58 | 52 | 77 |
| (20°) | | | | | | | | | |
| Rel. residual gloss (%) | 87 | 69 | 68 | 72 | 71 | 78 | 63 | 56 | 97 |
| Gloss after 2 h at 60° C. | 80 | 79 | 79 | 79 | 78 | 78 | 75 | 76 | 77 |
| Reflow | | | | | | | | | |
| Rel. residual gloss after | 92 | 89 | 89 | 89 | 88 | 90 | 82 | 82 | 97 |
| reflow (%) | | | | | | | | | |
| Chemical resistance | | | | | | | | | |
| Tree resin | 36 | 40 | 40 | 36 | 36 | 36 | 36 | 38 | 36 |
| Pancreatin | 36 | 36 | 36 | 36 | 36 | 36 | 36 | 36 | 36 |
| Deion. water | 42 | 42 | 45 | 45 | 42 | 42 | 40 | 44 | 36 |
| NaOH, 1% | 42 | 48 | 44 | 48 | 52 | 54 | 42 | 42 | 42 |
| H₂SO₄, 1% | 44 | 44 | 45 | 44 | 45 | 43 | 41 | 45 | 36 |

Testing Methods:
Pendulum Hardness:

The pendulum hardness was determined in accordance with DIN EN ISO 1522.

Petrol Resistance:

Testing with FAM test fuel to DIN 51 635, in a method based on VDA 621-412 (test A 4.1.1 Y and 4.1.3 Y) and xylene; exposure time 10 minutes:

Scratch Resistance:

The scratch resistance was determined in accordance with the DIN 55668 method of “Testing the scratch resistance of coatings with a laboratory wash unit”. The degree of gloss was measured as a reflectometer value in accordance with DIN 67 530 before and after stress by 10 back-and-forth strokes and also, again, after 2 h storage at 60° C. (reflow).

Chemical Resistance:

The chemical resistance was determined in accordance with DIN EN ISO 2812/5 (draft) in a gradient oven.

The coatings of the invention as per Examples 8 to 13 exhibit improved scratch resistance—both before and after reflow—as compared with Comparative Examples 1 and 2. The chemical resistance and particularly the acid resistance of the coatings of the invention is better in total than those of the comparative examples listed.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Coating compositions comprising
A) a polyol component comprised of
a) 1% to 50% by weight of aliphatic oligocarbonate polyols having a number-average molecular weight Mₙ of 200 to 5000 g/mol and
b) 50% to 99% by weight of hydroxy-functional polyacrylate polyols and
B) one or more OH-reactive (poly)isocyanate crosslinkers having an average NCO functionality of ≧2.0.

2. Coating compositions according to claim 1, wherein the amount of component a) is 1% to 10% by weight and the amount of component b) is 90% to 99% by weight.

3. Coating compositions according to claim 1, wherein in a) aliphatic oligocarbonate polyols having a molecular weight of 200 to 2000 g/mol and derived from 1,4-butanediol, 1,6-hexanediol, 3-methyl-1,5-pentanediol, cyclohexanedimethanol or mixtures thereof are used.

4. Coating compositions according to claim 1, wherein in b) copolymers of
b1) 0.4% to 5% by weight of one or more, optionally functional, polybutadienes having a number-average molecular weight of 500 to 2000 g/mol and having a 1,2-pendant vinylic double bond fraction of at least 40 mol %, based on all of the vinylic double bonds present in the polybutadiene,
b2) 5% to 20% by weight of styrene,
b3) 30% to 60% by weight of hydroxyethyl acrylate, hydroxyethyl methacrylate or mixtures thereof,
b4) 0 to 15% by weight of one or more compounds from the group consisting of isobornyl acrylate, isobornyl methacrylate, cyclohexyl (meth)acrylate, 3,5,5-trimethylcyclohexyl (meth)acrylate and 4-tert-butylcyclohexyl (meth)acrylate,
b5) 25% to 45% by weight of one or more esters of acrylic or methacrylic acid and aliphatic C₁ to C₄ monoalcohols,
b6) 0.5% to 2% by weight of acrylic acid, methacrylic acid or mixtures thereof and
b7) 0% to 15% by weight of one or more compounds from the group consisting of hydroxypropyl (meth)acrylate, vinyl esters of aliphatic, optionally branched C₁ to C₉ monocarboxylic acids, dialkyl esters or di(cyclo)alkyl esters of maleic or fumaric acid and C₃ to C₆ monoalcohols
are used, the sum of the weight percentages of components b1) to b7) being 100% by weight.

5. Coating compositions according to claim 4, wherein the copolymers used in b) have a polydispersity (M_{w}/Mₙ)≦2.5.

6. Coating compositions according to claim 1, wherein the polyol component A) is prepared by polymerizing the corresponding monomers of the copolymer b) in the aliphatic oligocarbonate polyols a).

7. Coating compositions according to claim 1, wherein in B) polyisocyanates or polyisocyanate mixtures with an isocyanurate structure, derived from HDI, IPDI and/or 4,4′-diisocyanatodicyclohexylmethane, are used.

8. Coating compositions according to claim 1, wherein the NCO/OH ratio of the free and optionally blocked NCO groups to the isocyanate-reactive groups is 0.5 to 1.2.

9. Coatings made from the coating compositions according to claim 1.

10. Substrates coated with coatings according to claim 9.
